(19) United States
(12) Patent Application Publication
(10) Pub. No.: US 2025/0102236 A1
(43) Pub. Date: Mar. 27, 2025

(54) HEAT EXCHANGER AND STRATIFICATION ASSEMBLIES

(71) Applicant: Alliance for Sustainable Energy, LLC, Golden, CO (US)

(72) Inventor: Eric KOZUBAL, Superior, CO (US)

(21) Appl. No.: 18/891,027

(22) Filed: Sep. 20, 2024

Related U.S. Application Data
(60) Provisional application No. 63/584,433, filed on Sep. 21, 2023.

(51) Int. Cl. F28D 20/00

(52) U.S. Cl. CPC F28D 20/0039

(57) ABSTRACT

The disclosure relates to stratification tank systems for heat exchangers. In some examples, a stratification tank system includes an outer tube, and a plurality of baffles within the outer tube configured to divert a flow of a first fluid from side-to-side through the outer tube. The stratification tank system also includes a plurality of inner tubes within the outer tube that extend through the plurality of baffles. In addition, each of the plurality of inner tubes is configured to flow a second fluid from a first end of the outer tube to a second end of the outer tube and into a diffusion chamber comprising a plurality of diffusion openings. Further, the plurality of diffusion openings are configured to flow the second fluid into a storage tank.

### CROSS-REFERENCE TO RELATED APPLICATION

This application claims the benefit of priority to U.S. Provisional Patent Application No. 63/584,433, filed on Sep. 21, 2023, the entire disclosure of which is expressly incorporated herein by reference to its entirety.

### CONTRACTUAL ORIGIN

This invention was made with government support under Contract No. DE-AC36-08GO28308 awarded by the Department of Energy. The government has certain rights in this invention.

### TECHNICAL FIELD

The disclosure relates generally to heat exchanger and stratification systems for heating, ventilation, and air conditioning systems.

### BACKGROUND

Heating, ventilation, and air conditioning (HVAC) systems generally cool ambient or room temperature air using a vapor compression refrigeration cycle. The HVAC systems may cool the ambient or room temperature air by removing heat using a refrigerant. In addition, the HVAC systems may include a heat exchanger that operates to remove the heat from the refrigerant.

### SUMMARY

In some examples, a stratification tank system includes an outer tube, and a plurality of baffles within the outer tube configured to divert a flow of a first fluid from side-to-side through the outer tube. The stratification tank system also includes a plurality of inner tubes within the outer tube that extend through the plurality of baffles. In addition, each of the plurality of inner tubes is configured to flow a second fluid from a first end of the outer tube to a second end of the outer tube and into a diffusion chamber comprising a plurality of diffusion openings. Further, the plurality of diffusion openings are configured to flow the second fluid into a storage tank.

In some examples, a stratification tank system includes a storage tank, and a heat exchanger positioned within the storage tank. The heat exchanger includes an outer tube configured to receive a first fluid from a top portion of the storage tank. The heat exchanger also includes a plurality of baffles within the outer tube configured to divert a flow of the first fluid side-to-side through the outer tube. Further, the heat exchanger includes a plurality of inner tubes within the outer tube that extend through the plurality of baffles. Each of the plurality of inner tubes is configured to flow a second fluid from a first end of the outer tube to a second end of the outer tube and into a diffusion chamber that has a plurality of diffusion openings. The plurality of diffusion openings are configured to flow the second fluid into a bottom portion of the storage tank.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 illustrates an arrangement of a stratification tube, in accordance with some embodiments;

FIG. 2 illustrates a stratification tank system, in accordance with some embodiments;

FIG. 3 illustrates an arrangement of a stratification tube, in accordance with some embodiments;

FIG. 4 illustrates a stratification tank system, in accordance with some embodiments; and

FIG. 5 illustrates an arrangement of a stratification tube, in accordance with some embodiments.

FIG. 6 illustrates a stratification tank system, in accordance with some embodiments.

FIG. 7 illustrates a stratification tank system, in accordance with some embodiments.

FIG. 8 illustrates a stratification tank system, in accordance with some embodiments.

FIG. 9 illustrates a stratification tank system, in accordance with some embodiments.

### DETAILED DESCRIPTION

The following discussion omits or only briefly describes conventional features of heat and mass exchangers that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “above” versus “below,” “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “operatively connected,” “operably connected,” and the like are such attachments, couplings, or connections that allow the pertinent structures to operate as intended by virtue of that relationship.

Embodiments of the present disclosure relate generally to heat exchangers and, more particularly, to stratification tank systems for heat exchangers. In some embodiments, the stratification tank systems can be used for liquid desiccant or other analogous systems. The stratification tank systems can include a heat exchanger comprising an outer tube that includes an entrance chamber where high concentration desiccant is received. The high concentration desiccant may be received from a regenerator, for example. An array of inner tubes pass the high concentration desiccant from the entrance chamber to a diffusion chamber of the outer tube. Once in the diffusion chamber, the high concentration desiccant passes through multiple diffusion openings and into a storage tank. For example, the high concentration desiccant may be provided to a bottom of the storage tank.

In addition, as the high concentration desiccant passes within the array of inner tubes, the high concentration desiccant is cooled by low concentration desiccant that passes within the outer tube and outside the array of inner tubes. The low concentration desiccant may be received from the storage tank, such as from the top of the storage tank. The outer tube may include multiple baffles that cause the low concentration desiccant to proceed through the outer tube in a side-to-side fashion. The flow of the low concentration desiccant may be counterflow to the flow of the high concentration desiccant. In this way, the high concentration desiccant from the regenerator transfers heat to the low concentration desiccant from the tank. After proceeding through the outer tube, the heated, low concentration desiccant may be provided to the regenerator.

The heat exchanger can be integrated into the storage tank as part of an integrated system. The integrated design slows the velocity of the high concentration (e.g., strong) desiccant by allowing the high concentration desiccant to at least partially fill the entrance chamber before the high concentration desiccant is directed into the inner tubes which, as described herein, operate as heat exchangers. The resulting velocity of high concentration desiccant at the exit of the inner tubes may be reduced to a quiescent flow by which desiccant density causes a stratification of the cooled high concentration desiccant, and flows out of the diffusion openings accordingly. In other words, the cooled high concentration desiccant will stratify according to its density (where the density is proportional to the desiccant's concentration). While the low concentration desiccant is received from the top of the storage tank, the high concentration desiccant is provided to the bottom of the storage tank. For instance, a halocline may be formed within the storage tank whereby low concentration (e.g., dilute) desiccant is above the halocline toward the top of the storage tank and higher concentration desiccant is below the halocline toward the bottom of the storage tank.

In some examples, a stratification tank system includes a heat exchanger with an outer tube, a plurality of baffles within the outer tube, and a plurality of inner tubes within the outer tube that extend through the plurality of baffles. The plurality of baffles are configured to divert a flow of a first fluid, such as low concentration desiccant, from side-to-side through the outer tube. The first fluid may be received, for example, from a top portion of the storage tank. Further, each of the plurality of inner tubes may pass through corresponding openings of the plurality of baffles. The inner tubes are configured to flow a second fluid, such as high concentration desiccant, from a first end of the outer tube to a second end of the outer tube and into a diffusion chamber. The second fluid may generally flow counterflow to the first fluid, and may be received, for example, from a regenerator. In addition, the diffusion chamber includes a plurality of diffusion openings that are configured to flow the second fluid into the storage tank. For instance, the plurality of diffusion openings may flow the second fluid into a bottom portion of the storage tank.

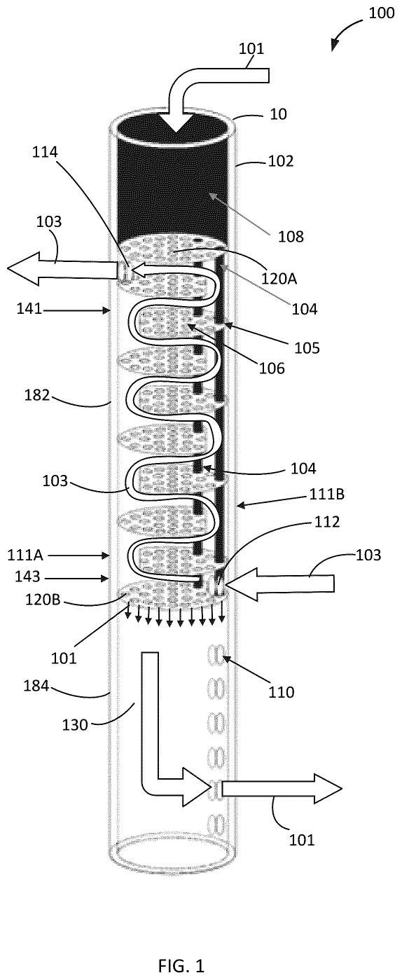

Referring to the drawings, FIG. 1 illustrates a stratification tank system 100 that includes stratification tube 10 that includes an outer tube 102, multiple inner tubes 104, and multiple baffles 106. In some examples, the multiple inner tubes 104 are manufactured out of any material with a high heat transfer coefficient (e.g., a metal or metal alloy), while the outer tube 102 may be manufactured out of any suitable insulating material (e.g., glass, metal, or plastic). Each of the inner tubes 104 and baffles 106 are located within the outer tube 102 in a heat exchanger section 182 that extends between a first tubesheet 120A and a second tubesheet 120B of the stratification tube 10. In addition, each of the inner tubes 104 extend from a first tubesheet 120A at a first end 141 of the outer tube 102 to a second tubesheet 120B at a second end 143 of the outer tube 102. Further, each of the inner tubes 104 pass through corresponding openings 105 of each of the baffles 106, as well as corresponding openings of the first tubesheet 120A and second tubesheet 120B.

As illustrated, while the tubesheets 120A, 120B have a surface area that coincides with the inner surface area of the outer tube 102, each of the baffles 106 have a surface area that is less than the inner surface area of the outer tube 102. For example, each of the baffles 106 may have a surface area that is in the range from 50% to 85% (e.g., 75%) of the cross-sectional area of the interior of the outer tube 102. The outer tube 102 also includes an entrance chamber 108 defined, at least in part, by the first tubesheet 120A. The entrance chamber 108 is configured to receive a high concentration fluid 101, such as high concentration desiccant. The high concentration fluid 101 may be received from a regenerator, for example. The multiple inner tubes 104 are configured to flow the high concentration fluid 101 from the entrance chamber 108 to a diffusion chamber 130 of the outer tube 102.

Additionally, a low concentration fluid 103, such as low concentration desiccant, is received through an entrance opening 112 of the outer tube 102. The low concentration fluid 103 may be received from a storage tank, such as the top of the storage tank. For example, a halocline may be formed within the storage tank whereby low concentration (e.g., dilute) desiccant extends from the top of the storage tank down to the halocline and higher concentration desiccant extends from the bottom of the storage tank up to the halocline. The baffles 106 are configured to divert the low concentration fluid 103 back and forth from one side 111A of the outer tube 102 to another side 111B of the outer tube 102 as the low concentration fluid 103 flows through the outer tube 102 from the second end 143 to the first end 141. The low concentration fluid 103 then flows out an exit opening 114 of the outer tube 102.

As illustrated, the low concentration fluid 103 generally flows counterflow to the high concentration fluid 101 flowing through the inner tubes 104. Further, the flow of the high concentration fluid 101 through the inner tubes 104 heats the low concentration fluid 103 flowing through the outer tube 102. Due to heat dissipation to the low concentration fluid 103, the high concentration fluid 101 may enter the diffusion chamber 108 at a cooler temperature than its temperature when it was received into the entrance chamber 108. Accordingly, the low concentration fluid 103 may exit the exit opening 114 at a higher temperature than its temperature when received into the entrance opening 112. As such, this portion of the stratification tank system 100 serves as a heat exchanger allowing for the exchange of heat between the low concentration fluid 103 and the high concentration fluid 101.

As further illustrated, the diffusion chamber 130 is located in a diffusion section 184 of the stratification tube 10, and includes multiple diffusion openings 110 that are configured to flow the high concentration fluid 101 from the diffusion chamber 130 to, for example, a storage tank (e.g., the bottom of the storage tank). In some examples, the diffusion chamber 130 includes a predetermined number of diffusion openings 110, such as anywhere from four to twenty or more diffusion openings 110. For example, the diffusion chamber 130 may include eight, ten, twelve, fourteen, or sixteen diffusion openings 110, or any other suitable number of diffusion openings 110. The number and size of the diffusion openings 110 can be selected to distribute the flow of the high concentration fluid so that it flows into a high concentration portion (e.g., bottom) of the tank at a rate that does not disturb the halocline.

Further, each of the diffusion openings 110 may have a predetermined area, such as an area of at least 0.04 inches squared (in²). In some examples, the predetermined area of the diffusion openings 110 is in the range from 0.04 in² to 0.20 in². In some instances, each diffusion opening 110 is spaced from each other diffusion opening 110 by at least 1 inch (in) and no more than 3 in. In some instances, each diffusion opening 110 is spaced from each other diffusion opening 110 by at least a predetermined amount, such as 2 in. In some instances, there are multiple diffusion openings around the circumference of the tube, such as four openings around the circumference of the tube. Further, in some examples, each of the diffusion openings 110 may be spaced apart from the tubesheet 120B by at least a predetermined amount, such as 16 in.

In some examples, high concentration fluid 101 flows from a regenerator into the entrance opening 112 of the stratification tank system 100, and flows out through various exit openings 114 (e.g., that act as diffusion openings 110) into a storage tank. In addition, low concentration fluid 103 is provided into the entrance chamber 108 of the stratification tank system 100 (e.g., from a storage tank), and flows out 120B into the diffusion chamber 130, and out through one or more of the diffusion openings 110 and to the regenerator.

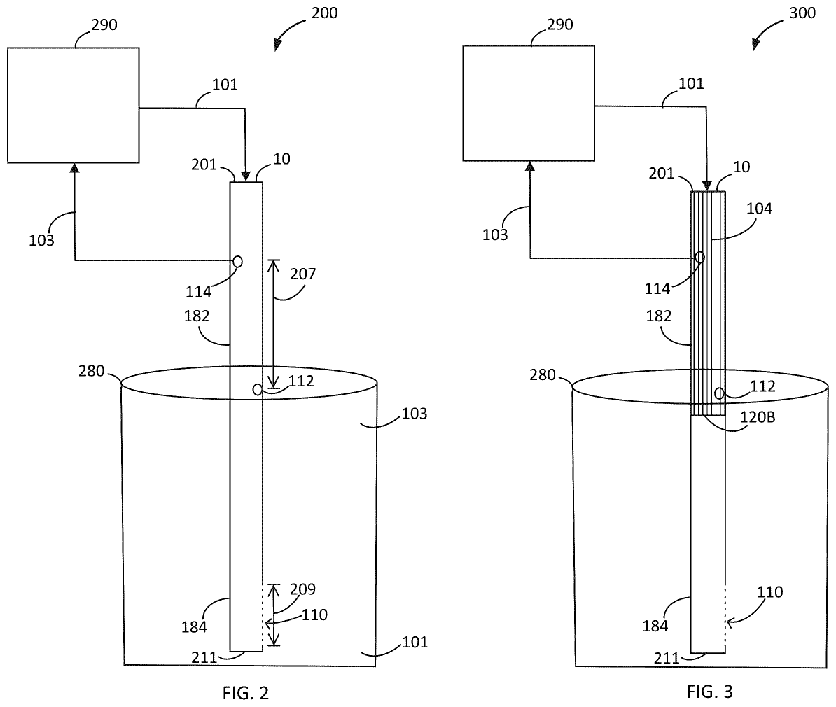

FIG. 2 illustrates a stratification tank system 200 that includes a stratification tube 10, a regenerator 290, and a storage tank 280. In this example, the stratification tube 10 includes a heat exchanger section 182 that extends a predetermined distance 207 from the exit opening 114 to the entrance opening 112 of the stratification tube 10. The stratification tube 10 may also include a diffusion section 184 that includes multiple diffusion openings 110, and extends a predetermined distance 209 along a lower portion of the stratification tube 10. In some examples, the predetermined distance 207 of the heat exchanger section 182 is in the range from 12 in to 36 in. Further, in some examples, the predetermined distance 209 of the diffusion section 184 is in the range from 12 in to 36 in.

As illustrated, the regenerator 290 may feed high concentration fluid 101 into the stratification tube 10 near the first end 201. The high concentration fluid 101 may then flow through the heat exchanger section 182, into the diffusion section 184, and out the diffusion openings 110 into a bottom portion of the storage tank 280. In addition, low concentration fluid 103 from the top of the storage tank 280 may flow into the entrance opening 112, flow through the heat exchanger section 182, and flow out of the exit opening 114 and into the regenerator 290 for regeneration.

FIG. 3 illustrates a stratification tank system 300 that includes multiple inner tubes 104 within the heat exchanger section 182 of the stratification tube 10. The multiple inner tubes 104 extend throughout the heat exchanger section 182 and, in this example, from the first end 201 of the stratification tube 10 to the tubesheet 120B located within the stratification tube 10. As described herein, a high concentration fluid may flow through the inner tubes 104 and into the diffusion section 184 of the stratification tube 10. The high concentration fluid may then proceed out of the stratification tube 10 through the diffusion openings 110.

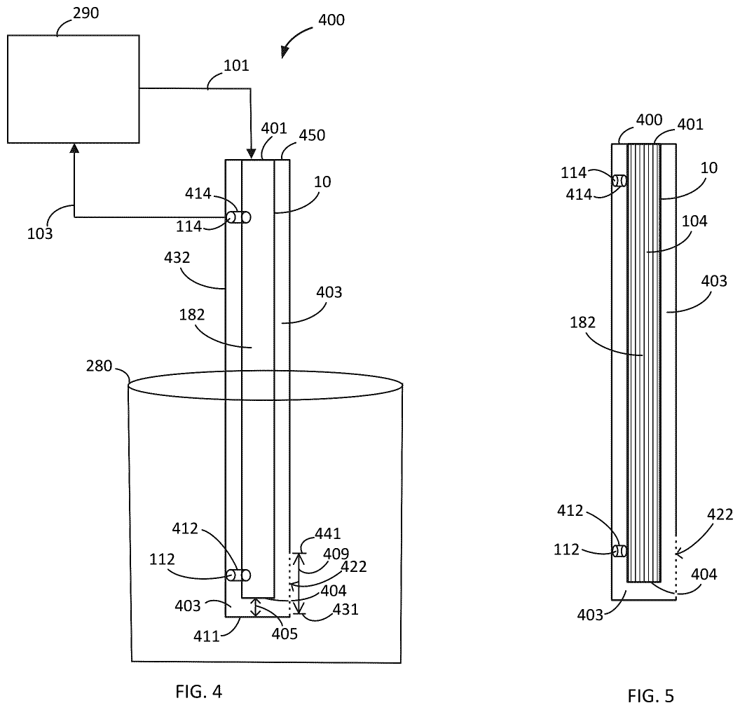

FIG. 4 illustrates a stratification tank system 400 that may allow for a longer heat exchanger. The stratification tank system 400 includes a stratification assembly 450, a regenerator 290, and a storage tank 280. The stratification assembly 450 includes a stratification tube 10 and an outer tube 432. The stratification tube 10 includes a heat exchanger section 182 that facilitates a flow of high concentration fluid, such as high concentration desiccant, from a first end 401 to a second end 404 of the stratification tube 10. As described herein, the heat exchanger section 182 may include inner tubes 104 passing through corresponding openings 105 of multiple baffles 106. In this example, a cavity 403 is formed between the stratification tube 10 and the outer tube 432. As such, high concentration fluid may flow through the heat exchanger section 182 of the stratification tube 10, and may exit the stratification tube 10 at its second end 404 and into the cavity 403. As the cavity 403 fills with the high concentration fluid, the high concentration fluid may flow out of the outer tube 432 via the diffusion openings 422.

In this example, the second end 404 of the stratification tube 10 may be a predetermined distance 405 from the second end 411 of the outer tube 432. The predetermined distance 405 may be, for example, in the range from 0.5 in to 2 in. In addition, the diffusion openings 422 may extend throughout a portion 409 of the outer tube 432. For example, the diffusion openings 422 may extend from a first position 431 to a second position 441 of the outer tube 432.

As illustrated, the regenerator 290 may feed high concentration fluid 101 into the stratification tube 10 near the first end 401. The high concentration fluid 101 may then flow through the heat exchanger section 182 of the stratification tube 10, out the second end 404, and into the cavity 403. The high concentration fluid 101 may begin to fill the cavity 403, and flow out of the diffusion openings 422 and into the storage tank 280 (e.g., a bottom portion of the storage tank 280). In addition, low concentration fluid 103 from the top of the storage tank 280 may flow through the entrance opening 112 and into an entrance passageway 412 that facilitates the flow of the low concentration fluid 103 through the outer tube 432 and into the stratification tube 10. The low concentration fluid 103 may then flow through the heat exchanger section 182 of the stratification tube 10. As described herein, the low concentration fluid 103 may be diverted by baffles 106 as it flows through the heat exchanger section 182 of the inner tube 402. After proceeding through the heat exchanger section 182, the low concentration fluid 103 may flow through an exit passageway 414 that facilitates the flow of the low concentration fluid 103 out of the stratification tube 10 and through the exit opening 114 of the outer tube 432. The low concentration fluid 103 may flow out of the exit passageway 414 and into the regenerator 290 for regeneration.

FIG. 5 illustrates multiple inner tubes 104 housed within the heat exchanger section 182 of the stratification tube 10. As described herein, the heat exchanger section 182 may include inner tubes 104 passing through corresponding openings 105 of multiple baffles 106. Here, the high concentration fluid 101 may flow into the multiple inner tubes 104 at the first end 401 of the stratification tube 450, through the heat exchanger section 182 of the stratification tube 10. The high concentration fluid 101 may then flow out of the multiple inner tubes 104 at the second end 404 of the stratification tube 10 and into the cavity 403. Further, the high concentration fluid may flow out of the cavity 403 through the diffusion openings 422. For instance, the high concentration fluid 101 may flow out of the diffusion openings 422 and into a storage tank (e.g., storage tank 280).

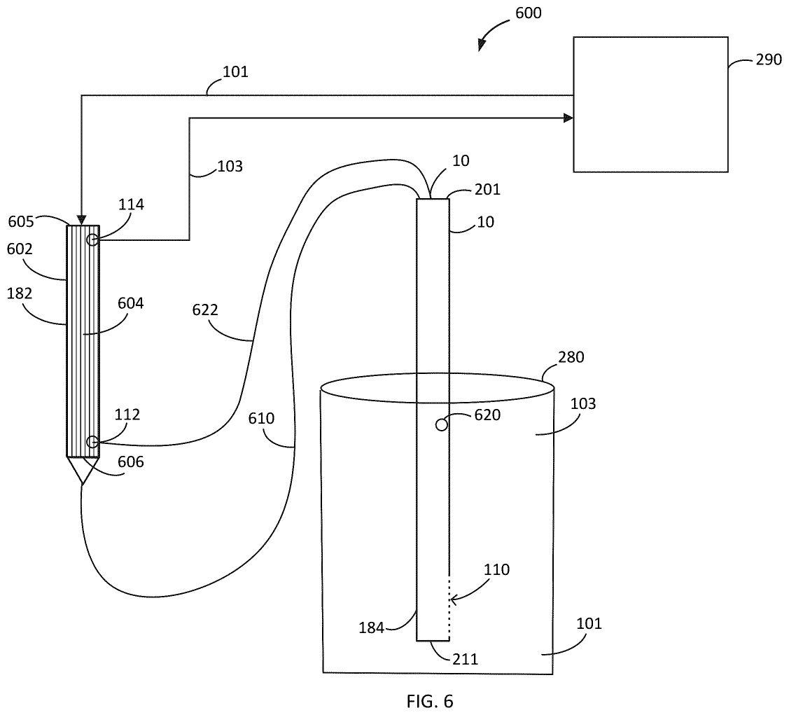

FIG. 6 illustrates a stratification tank system 600 that includes a tube housing 602 housing multiple inner tubes 604, the stratification tube 10, the regenerator 290, and the storage tank 280. In this example, the regenerator 290 may feed a high concentration fluid 101 to each of the multiple inner tubes 604 at a first end 605 of the tube housing 602. The high concentration fluid 101 may flow through the multiple inner tubes 604 and exit out at a second end 606 of the tube housing 602. The high concentration fluid 101 may then flow through one or more hoses 610 to the first end 201 of the stratification tube 10. Further, the high concentration fluid 101 may flow into the diffusion section 184 of the stratification tube 10, and flow out the diffusion openings 110 and into a bottom portion of the storage tank 280. In addition, low concentration fluid 103 from the top of the storage tank 280 may flow into an entrance opening 620 of the stratification tube 10, flow through the stratification tube, and into one or more hoses 622. The low concentration fluid 102 may flow through the one or more houses and into the tube housing 602 through an entrance opening 112. The low concentration fluid 102 may then flow through the heat exchanger section 182, out of an exit opening 114, and into the regenerator 290 for regeneration.

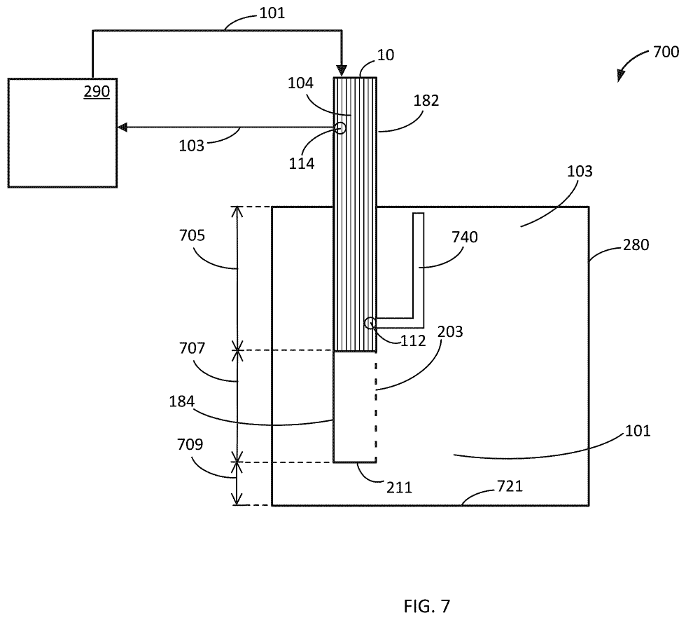

FIG. 7 illustrates a stratification tank system 700 that includes the stratification tube 10 at least partially submerged within a storage tank 280, and a regenerator 290 in fluid communication with the stratification tube 10. The storage tank 280 may store high concentration fluid 101, such as high concentration desiccant. In this example, the diffusion section 184, and at least a portion of the heat exchanger section 182, of the stratification tube 10 are submerged within the storage tank 280. For example, the heat exchanger section 182 of the stratification tube 10 may extend at least a first predetermined distance 705 into the storage tank 280. The first predetermined distance 705 may be in the range from 12 in to 24 in, such as 16 in.

As illustrated, the diffusion section 184 of the stratification tube 10 is fully submerged within the storage tank 280, and may have a predetermined length 707 from 12 in to 36 in, such as 20 in. The high concentration fluid 101 is received from the regenerator 290, and may proceed through the multiple inner tubes 104 and into the diffusion section 184 of the stratification tube 10. The high concentration fluid 101 may then proceed out of the stratification tube 10 through the diffusion openings 110 and into the storage tank 280, such as a bottom portion of the storage tank 280. In some examples, the second end 211 of the stratification tube 10 is a predetermined distance 709 from a bottom 721 of the storage tank 280. The predetermined distance 709 may be, in some instances, from 0 in to 2 in, such as 0.5 in.

Further, a tube 740 may feed low concentration fluid 103 from the top of the storage tank 280 into the entrance opening 112. The tube 740 may, in some examples, be attached to a float so fluid level doesn't cause a malfunction (i.e., no fluid intake). The low concentration fluid 103 flows through the heat exchanger section 182, and then flows out of the exit opening 114 and into the regenerator 290 for regeneration.

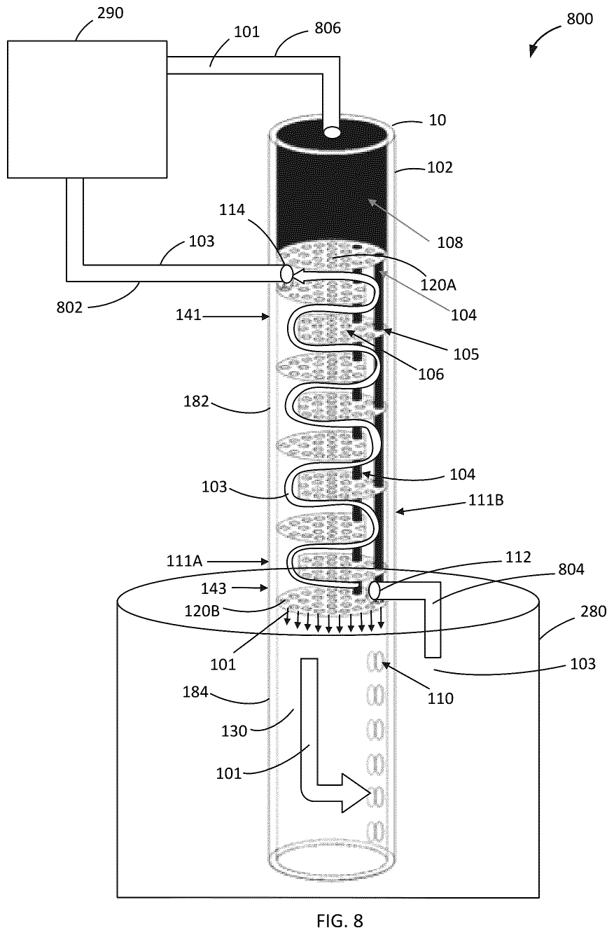

FIG. 8 illustrates a stratification tank system 800 that includes the stratification tube 10, a storage tank 280, and a regenerator 290. In this example, the regenerator 290 may feed high concentration fluid 101 to the stratification tube 10 over one or more pipes (e.g., PVC pipes) 806. The high concentration fluid 101 may then flow through the multiple inner tubes 104 of the stratification tube 10 and out of the diffusion openings 110 into the storage tank 280 (e.g., a bottom portion of the storage tank 280), as described herein. In addition, low concentration fluid 103 from the top of the storage tank 280 may flow over one or more pipes 804 into the entrance passageway 112 of the stratification tube 10. The low concentration fluid 103 may flow through the stratification tube 10, being diverted side to side by the baffles 106, and proceed to the exit passageway 114. The low concentration fluid 103 may then flow out of the exit passageway 114 and flow over one or more pipes 802 into the regenerator 290 for regeneration.

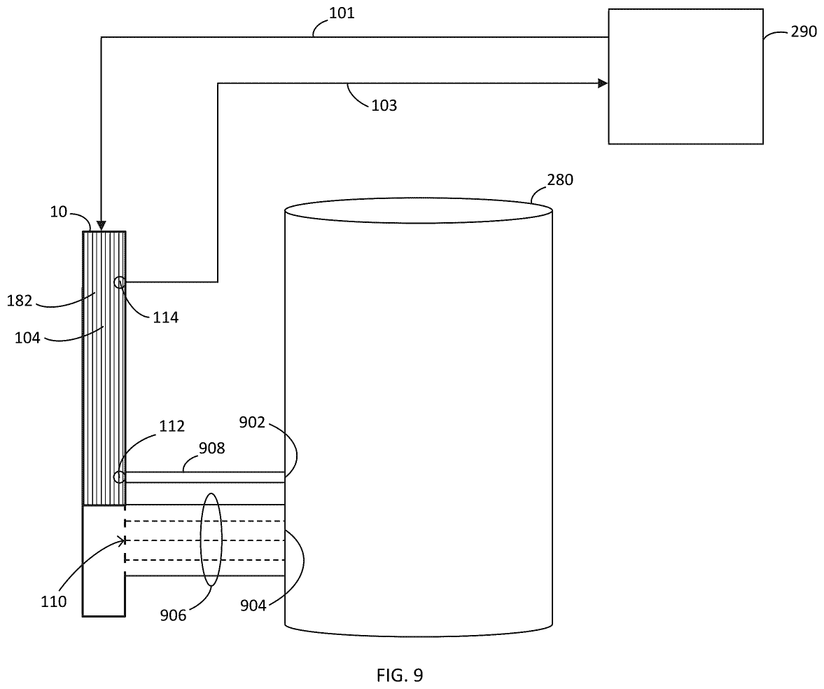

FIG. 9 illustrates a stratification tank system 1000 that includes the stratification tube 10, a storage tank 280, and a regenerator 290 in fluid communication with the stratification tube 10. In this example, the stratification tube 10 is outside the storage tank 280, and in fluid communication with the storage tank 280 through one or more tubes 906, 908. For instance, the stratification tube 10 may be attached (e.g., bolted) to a side of the storage tank 280. A tube 908 may receive the low concentration fluid 103 through an opening 902 in the side of the storage tank 280. The low concentration fluid 103 may flow through the tube 908 and flow into entrance opening 112 of the outer tube 102. As described herein, the low concentration fluid 103 may be diverted by baffles as it flows through the outer tube 102. The low concentration fluid 103 may then flow out of the exit opening 114 and to the regenerator 290 for regeneration. Additionally, the stratification tube 10 may receive the high concentration fluid 101 from the regenerator 290. The high concentration fluid 101 then flows through the multiple inner tubes 104 of the stratification tube 10 and out of the diffusion openings 110 into one or more tubes 906 that deliver the high concentration fluid 101 to the storage tank 280 (e.g., to a bottom portion of the storage tank 280).

Among other advantages, the embodiments can allow for heat exchange between a high concentration fluid, such as a high concentration desiccant received from a regenerator, and a low concentration fluid, such as a low concentration desiccant received from a storage tank. In particular, the low concentration fluid may flow through an outer tube of a stratification tank assembly while the high concentration fluid flows through inner tubes of the stratification tank assembly, and thereby cools the high concentration fluid. The cooled high concentration fluid may exit the stratification tank assembly through diffusion openings and be provided into the storage tank.

For instance, in some examples, a stratification tank assembly includes an outer tube with an entrance chamber that receives high concentration desiccant. The high concentration desiccant may be received from a regenerator, for example. An array of inner tubes pass the high concentration desiccant from the entrance chamber to a diffusion chamber of the outer tube. Once in the diffusion chamber, the high concentration desiccant passes through multiple diffusion openings and into a storage tank. For example, the high concentration desiccant may be provided to a bottom of the storage tank. In addition, as the high concentration desiccant passes within the array of inner tubes, the high concentration desiccant is cooled by low concentration desiccant passing within the outer tube and outside the array of inner tubes. For instance, the outer tube may include multiple baffles that cause the low concentration desiccant to proceed through the outer tube in a side-to-side fashion, thereby cooling the high concentration desiccant flowing through the inner tubes. As such, the low concentration desiccant, which may be received from a storage tank (e.g., the top of the storage tank), is heated. After proceeding through the outer tube, the now heated low concentration desiccant may be provided to the regenerator for regeneration.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

What is claimed is:

1. A stratification tank system, comprising:
an outer tube;
a plurality of baffles within the outer tube configured to divert a flow of a first fluid from side-to-side through the outer tube; and
a plurality of inner tubes within the outer tube that extend through the plurality of baffles, wherein each of the plurality of inner tubes is configured to flow a second fluid from a first end of the outer tube to a second end of the outer tube and into a diffusion chamber comprising a plurality of diffusion openings, wherein the plurality of diffusion openings are configured to flow the second fluid into a storage tank.

2. The stratification tank system of claim 1, wherein the plurality of diffusion openings comprise at least eight diffusion openings.

3. The stratification tank system of claim 2, wherein the plurality of diffusion openings comprise twelve diffusion openings.

4. The stratification tank system of claim 1, wherein each of the plurality of diffusion openings have an area of at least 0.04 inches squared.

5. The stratification tank system of claim 1, wherein each of the plurality of diffusion openings are spaced at least 1 inch from each other.

6. The stratification tank system of claim 1, wherein each of the plurality of diffusion openings are configured to flow the second fluid into a lower portion of the storage tank.

7. The stratification tank system of claim 1, wherein the outer tube is configured to receive the first fluid through an opening at the second end.

8. The stratification tank system of claim 1, wherein the first fluid is received from the storage tank.

9. The stratification tank system of claim 8, wherein the first fluid is received from an upper portion of the storage tank.

10. The stratification tank system of claim 8, wherein the second fluid is provided from the second end of the outer tube to a lower portion of the storage tank.

11. The stratification tank system of claim 1, wherein the outer tube is configured to feed the first fluid out through an opening at the first end.

12. The stratification tank system of claim 11, wherein the first fluid is fed to a regenerator.

13. The stratification tank system of claim 1 comprising a top chamber configured to receive the second fluid from a regenerator and feed the second fluid to the plurality of inner tubes.

14. The stratification tank system of claim 1, wherein the flow of the first fluid is counterflow a flow of the second fluid.

15. The stratification tank system of claim 1, wherein the first fluid is low concentration liquid desiccant.

16. The stratification tank system of claim 1, wherein the second fluid is high concentration liquid desiccant.

17. The stratification tank system of claim 1, wherein the plurality of inner tubes are comprised of one or more metals.

18. The stratification tank system of claim 1, wherein the flow of the first fluid through the outer tube causes heat to be transferred from the second fluid to the first fluid.

19. The stratification tank system of claim 1, wherein a surface area of each of the plurality of baffles comprises at least 50% of a cross-sectional area of an interior of the outer tube.

20. The stratification tank system of claim 1, wherein the plurality of baffles are located between a first opening at the first end of the outer tube and a second opening at the second end of the outer tube.

21. The stratification tank system of claim 1, wherein each of the plurality of inner tubes pass through corresponding openings of the plurality of baffles.

22. The stratification tank system of claim 1, wherein the plurality of baffles are configured to divert the flow of the second fluid transversely within the outer tube.

23. The stratification tank system of claim 1, wherein the diffusion chamber is defined at least in part by a tubesheet.

24. The stratification tank system of claim 1, wherein the outer tube is configured to provide the first fluid to a regenerator.

25. A stratification tank system comprising:
a storage tank; and
a heat exchanger positioned within the storage tank, the heat exchanger comprising:
an outer tube configured to receive a first fluid from a top portion of the storage tank;
a plurality of baffles within the outer tube configured to divert a flow of the first fluid side-to-side through the outer tube; and
a plurality of inner tubes within the outer tube that extend through the plurality of baffles, wherein each of the plurality of inner tubes is configured to flow a second fluid from a first end of the outer tube to a second end of the outer tube and into a diffusion chamber comprising a plurality of diffusion openings, wherein the plurality of diffusion openings are configured to flow the second fluid into a bottom portion of the storage tank.

26. The stratification tank system of claim 25, wherein the heat exchanger is configured to receive the second fluid from a regenerator.
